(19) United States
(12) Patent Application Publication
(10) Pub. No.: US 2025/0134762 A1
(43) Pub. Date: May 1, 2025

(54) METHODS, SYSTEMS, AND ASSEMBLIES FOR TRANSMITTING A VIBROACOUSTIC STIMULATION INTO A MATTRESS

(71) Applicant: Tempur World, LLC, Lexington, KY (US)

(72) Inventors: Thomas A. Zakowski, JR., Lexington, KY (US); Mark King, Lexington, KY (US); Scott Powell, Lexington, KY (US); Paul Griese, Lexington, KY (US); Brent Pfister, Lexington, KY (US)

(21) Appl. No.: 18/867,663

(22) PCT Filed: Jan. 22, 2024
(86) PCT No.: PCT/US2024/012361

§ 371 Date: Nov. 20, 2024

Related U.S. Application Data
(60) Provisional application No. 63/480,861, filed on Jan. 20, 2023.

(51) Int. Cl. A61H 23/02; A47C 20/08

(52) U.S. Cl. CPC A61H 23/0236; A47C 20/08; A61H 2201/0146; A61H 2201/1604; A61H 2201/164; A61H 2201/5012; A61H 2201/5097; A61H 2230/00

(57) ABSTRACT

Methods, systems, and assemblies for providing a vibroacoustic stimulation to a user resting on a mattress are provided and make use of a power base assembly. The power base assembly includes a support surface for supporting the mattress, a frame operably connected to the support surface. and one or more sound transducers operably connected to the support surface and/or the frame. The one or more sound transducers are positioned at predetermined locations on the support surface and/or the frame, and a controller is connected to each of the one or more sound transducers. The controller receives and transmits instructions from a remote control. a cloud-based application, or a mobile device in communication with the controller and causes the sound transducers to emit a vibroacoustic stimulation in a predetermined pattern of frequencies or intensities.

### RELATED APPLICATIONS

This application claims priority from U.S. Provisional Application Ser. No. 63/480,861, filed Jan. 20, 2023, the entire disclosure of which is incorporated herein by this reference.

### TECHNICAL FIELD

The present invention relates to methods, systems, and assemblies for transmitting a vibroacoustic stimulation into a mattress. In particular, certain embodiments of the present invention relate to methods, systems, and assemblies for transmitting a vibroacoustic stimulation into a mattress whereby one or more sound transducers are made to emit a vibroacoustic stimulation into a mattress and to do so in a predetermined pattern of frequencies and/or intensities.

### BACKGROUND

Bed assemblies that make use of power bases (a.k.a., powered foundations) are becoming increasingly popular as an alternative to traditional bed assemblies. Unlike traditional bed assemblies that make use of rigid box springs or other similar bases, a bed assembly that makes use of a power base allows a user to customize their comfort and add features to their bed, including, for example, the ability to articulate the power base into a desired ergonomic position, the ability to play sounds or music, and the ability to provide a massage to the user. For example, in power bases including an adjustable base, a user can readily change the position of the mattress lying on the adjustable base and, consequently, can quickly match the position of the mattress to their specific preferences and, at least partially, individualize his or her level of sleep comfort.

Despite the readily adjustable and customizable nature of such power base assemblies, the use of such power bases has, to date, typically focused on providing a general therapeutic effect to a user rather than specifically targeting how best to improve the sleep quality of the user or how best to alleviate any particular ailments the user may be experiencing. Accordingly, methods, systems, and/or power base assemblies that are capable of targeting specific ailments, such as back pain, shoulder pain, anxiety, acid reflux, and the like, while also helping a user fall asleep faster, spend more time in deep sleep, and/or improve the duration of sleep with less wakeful time would be both highly desirable and beneficial.

### SUMMARY

The present invention includes methods, systems, and assemblies for transmitting a vibroacoustic stimulation into a mattress. In particular, certain embodiments of the present invention include methods, systems, and assemblies for transmitting a vibroacoustic stimulation into a mattress whereby one or more sound transducers are made to emit a vibroacoustic stimulation into a mattress resting on the upper surface of a power base assembly.

In one exemplary implementation of a method for providing a vibroacoustic stimulation to a user resting on a mattress in accordance with the present invention, a power base assembly for a mattress is first provided. The power base assembly includes a support surface for supporting the mattress, with the support surface including a first upper side and a second lower side. A frame is positioned adjacent to and is operably connected to the second lower side of the support surface, and one or more sound transducers are then operably connected to the support surface and/or the frame, and are positioned at predetermined locations on the support surface and/or the frame. A controller is further operably connected to each of the one or more sound transducers and includes a communications module and a processor.

In the exemplary method, the controller of the power base assembly receives instructions to cause the one or more sound transducers to emit a vibroacoustic stimulation in a predetermined pattern of frequencies or intensities. Based on the instructions received by the controller, the controller then subsequently transmits a signal to the one or more sound transducers to cause the one or more sound transducers to emit a vibroacoustic stimulation in the predetermined pattern of frequencies or intensities. In some implementations, the predetermined pattern of frequencies or intensities of vibroacoustic stimulation comprises a first frequency or intensity of vibroacoustic stimulation emitted for a first period of time, and a second frequency or intensity of vibroacoustic stimulation emitted for a second period of time. In some implementations, the first frequency or intensity of vibroacoustic stimulation is different than the second frequency or intensity of vibroacoustic stimulation. In some implementations, the first period of time is different than the second period of time.

With further respect to the transmission of instructions to the controller, in some implementations, the instructions are transmitted to the controller from a remote control, from a cloud-based application, and/or from a mobile device. In some implementations, an exemplary power base assembly further comprises one or more biometric sensors for measuring one or more biological characteristics of a user, and the instructions received and/or transmitted by the controller are based on the one or more biological characteristics of a user. In this way, the signal transmitted to the one or more sound transducers can then cause the one or more sound transducers to emit a particular vibroacoustic stimulation based on the one or more biological characteristics of the user. In some implementations that make use of such biometric sensors for measuring one or more biological characteristics of a user, the one or more measured biological characteristics of the user are transmitted to a mobile device via a software application running on the mobile device or are transmitted to a cloud-based application. The biological characteristics are then processed by the software application on the mobile device or by the cloud-based application to identify a sleep status of a user. Based on the identified sleep status, the software application on the mobile device or the cloud-based application can then transmit instructions to the controller, either directly or indirectly, to emit a particular vibroacoustic stimulation based on the identified sleep status of the user.

In addition to the biometric sensors, in some implementations of the methods, an exemplary power base assembly further makes use of and includes an articulating frame having a head portion and a foot portion, whereby instructions are received by the controller from a remote control, a cloud-based application, or a mobile device to articulate the head portion and/or the foot portion of the frame. After receiving those instructions, the controller then transmits a signal to one or more actuators operably connected to the head portion or the foot portion of the frame to articulate the head portion or the foot portion of the frame. In some implementations, those instructions to articulate the head and/or foot portion of the frame are transmitted to the controller via a software application on the mobile device or via a cloud-based application, and are based on an identified sleep status or other biometric of the user.

Further provided, in some embodiments of the presently-disclosed subject matter, are systems for providing a vibroacoustic stimulation to a user resting on a mattress. In some embodiments, a system for providing a vibroacoustic stimulation to a user resting on a mattress comprises a support surface for supporting a mattress. The support surface includes a first upper side and a second lower side, and a frame is positioned adjacent to and is operably connected to the second lower side of the support surface. In the system, one or more sound transducers are further operably connected to the support surface and/or the frame, with the one or more sound transducers positioned at predetermined locations on the support surface and/or the frame and configured to emit a vibroacoustic stimulation into the mattress resting on the support surface. A controller is operably connected to each of the one or more sound transducers. The controller includes a communications module and a processor, and individually controls, at least in part, the vibroacoustic stimulation emitted by each of the one or more sound transducers. The system further includes a remote control, a cloud-based application, or a mobile device in communication with the controller, such that the controller is configured to receive instructions from the remote control, the cloud-based application, or the mobile device and then cause the one or more sound transducers to emit a vibroacoustic stimulation in a predetermined pattern of frequencies or intensities.

In some embodiments of the systems, the frame is an articulating frame including a head portion and a foot portion, such that instructions can be communicated to the controller, e.g., via the software application on the mobile device or via a cloud-based application, to articulate a head or a foot portion of the frame, or both. In some embodiments, the systems also include one or more biometric sensors for measuring one or more biological characteristics of a user resting on the mattress. In such embodiments, the software application on the mobile device or the cloud-based application are configured to communicate instructions, either directly or indirectly, to the controller to cause the one or more sound transducers to emit a vibroacoustic stimulation in a predetermined pattern of frequencies or intensities based on the measurement of the one or more biological characteristics.

Still further provided, in some embodiments of the present invention, are power base assemblies. In some embodiments, a power base assembly is provided that comprises a support surface for supporting a mattress, and having a first upper side and a second lower side. A frame is positioned adjacent to and operably connected to the second lower side of the support surface. One or more sound transducers are operably connected to either the support surface and/or the frame and are positioned at predetermined locations on the support surface and/or the frame, such that the sound transducers are configured to emit a vibroacoustic stimulation into a mattress resting on the support surface. To individually control the vibroacoustic stimulation emitted by the sound transducers, a controller is operably connected to each of the one or more sound transducers and is configured to cause the one or more sound transducers to emit a vibroacoustic stimulation in a predetermined pattern of frequencies or intensities.

Similar to the methods and systems described above, in some embodiments of the power base assemblies of the present invention, the frame is an articulating frame. For instance in some embodiments, the frame includes a head portion and a foot portion, and the one or more sound transducers comprise a first pair of sound transducers positioned adjacent to the head portion of the frame and a second pair of sound transducers positioned adjacent to the foot portion of the frame. In some embodiments, each of the one or more sound transducers are configured to emit a vibroacoustic stimulation at frequencies ranging from about 20 Hz to about 150 Hz. In some embodiments, a sound bar is further included in the power base assembly and is operably connected to the one or more sound transducers in a manner whereby the sound bar transmits an audio signal to the one or more sound transducers via the controller.

The exemplary power bases described herein, and again similar to the methods and systems of the present invention, also make use of and include one or more sensors operably connected to the controller. In some embodiments, an exemplary power base assembly comprises one or more biometric sensors that are operably connected to the controller and that measure one or more biological characteristics of a user resting on the mattress such that the biometric sensors can then provide input to the controller, either directly or indirectly, to cause the one or more sound transducers to emit a vibroacoustic stimulation in a predetermined pattern of frequencies or intensities in response to the measured biological characteristics. In some embodiments, an exemplary power base assembly further comprises one or more environmental sensors that measure a local environmental condition, such that the environmental sensors are capable of providing, in certain embodiments, input to the controller, either directly or indirectly, to cause the one or more sound transducers to emit a vibroacoustic stimulation in a predetermined pattern of frequencies or intensities in response to the measured local environmental condition.

Further features and advantages of the present invention will become evident to those of ordinary skill in the art after a study of the description, figures, and non-limiting examples in this document.

### BRIEF DESCRIPTION OF THE DRAWINGS

FIG. 1 is a side view of a power base assembly in accordance with one embodiment of the present invention;

FIG. 2 is a bottom view of the power base assembly of FIG. 1;

FIG. 3 is a schematic diagram showing the components included in an exemplary system for transmitting a vibroacoustic stimulation into a mattress in accordance with the present invention;

FIG. 4 is a schematic diagram showing one exemplary system for transmitting a vibroacoustic stimulation into a mattress in accordance with the present invention;

FIG. 5 is a schematic diagram showing another exemplary system for transmitting a vibroacoustic stimulation into a mattress in accordance with the present invention;

FIG. 6 is a schematic diagram showing another exemplary system for transmitting a vibroacoustic stimulation into a mattress in accordance with the present invention; and

FIG. 7 is a schematic diagram showing exemplary sleep cycles of a user over a period of one night, and further showing points of intervention with the methods, systems, and power base assemblies of the present invention to thereby improve the user's sleep.

### DESCRIPTION OF EXEMPLARY EMBODIMENTS

The present invention includes methods, systems, and assemblies for transmitting a vibroacoustic stimulation into a mattress. In particular, certain embodiments of the present invention include methods, systems, and assemblies for transmitting a vibroacoustic stimulation into a mattress whereby one or more sound transducers are made to emit a vibroacoustic stimulation into a mattress resting on the upper surface of a power base to thereby provide relief of the aches and pains along with the stress and anxiety of the user, and/or to improve the user's sleep. As described in further detail below, in some embodiments, the vibroacoustic stimulations emitted by the one or more sound transducers are based on measured biological characteristics of the user resting on a mattress and/or are based on a predetermined pattern of frequencies or intensities configured to improve a user's sleep.

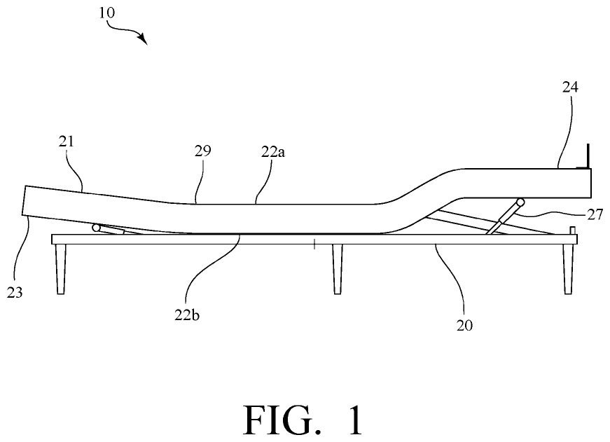

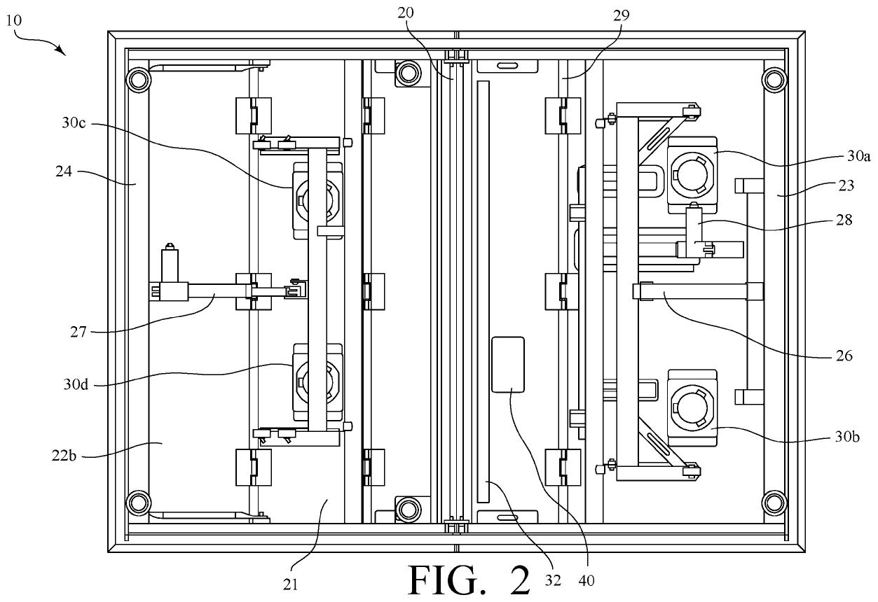

Referring first to FIGS. 1-3, in one exemplary embodiment of the present invention, the methods, systems, and assemblies for transmitting a vibroacoustic stimulation into a mattress make use of and include a power base assembly 10 that comprises a frame 20 operably connected to a support surface 21. The support surface 21 has a first upper side 22a for supporting a mattress and a second lower side 22b that is opposite the upper side 22a and that adjacent to which additional features of the power base assembly 10 are located. In particular, in the exemplary power base assembly 10 shown in FIGS. 1-3, the frame 20 of the power base assembly 10 is an articulating frame that includes a head portion 23 and a foot portion 24. A first actuator 26 is attached or otherwise operably connected to the head portion 23 of the frame 20 for articulating the head portion 23 of the frame 20, while a second actuator 27 is attached or otherwise operably connected to the foot portion 24 of the frame 20 for articulating the foot portion 24 of the frame 20. Additionally, in the power base assembly 10, a third actuator 28 is attached or otherwise operably connected to a lumbar portion 29 of the frame 20 for articulating the lumbar portion 29 of the frame 20.

As further shown in FIGS. 1-3, the power base assembly 10 additionally includes one or more sound transducers 30a, 30b, 30c, 30d that are operably connected to the frame 20 and that are positioned at predetermined locations on the frame such that the sound transducers 30a, 30b, 30c, 30d are configured to emit a vibroacoustic stimulation into a mattress resting on the upper side 22a of the support surface 21 positioned on the frame 20. More specifically, in the embodiments shown in FIGS. 1-3, the sound transducers 30a, 30b, 30c, 30d are arranged such that a first pair of sound transducers 30a, 30b is attached to the lower side 22b of the support surface 21 with the sound transducers 30a, 30b spaced apart from one another on opposite sides of the power base assembly 10 adjacent to the head portion 23 of the frame 20. A second pair of sound transducers 30c, 30d is then attached to the lower side 22b of the support surface 21 such that the sound transducers 30c, 30d are spaced apart from one another on opposite sides of the power base assembly 10 adjacent to the foot portion 24 of the frame 20. In some embodiments, it is further contemplated that traditional massage motors can also be included in an exemplary assembly in a manner that is independent from or that interacts with the exemplary sound transducers without departing from the spirit and scope of the subject matter described herein.

Each of the sound transducers 30a, 30b, 30c, 30d included in the power base assembly 10 is generally configured to emit a vibroacoustic stimulation at a frequency ranging from about 20 Hz to about 150 Hz, including, in certain embodiments, a frequency response ranging from about 20 Hz to about 100 Hz or a frequency response ranging from about 20 Hz to about 75 Hz, as described in further detail below. Moreover, in the power base assembly 10, each of the sound transducers 30a, 30b, 30c, 30d has a power handling (RMS/Peak) of about 40/80, an impedance of about 8 ohm, a resonant frequency (Fs) of about 40 Hz, a force peak (lbs./ft.) of about 40, and is about 4.8 inches in diameter and about 1.57 inches in height. Each of the sound transducers 30a, 30b, 30c, 30d are also generally configured to be mounted to the support surface 21 of the power base assembly 10 by making use of a mounting plate or similar assembly and inserting the sound transducers 30a, 30b, 30c, 30d into a hole that is cut into the support surface 21 of the power base assembly 10 and that has dimensions of about 7.6 inches in length and about 6.4 inches in width, such that the sound transducers 30a, 30b, 30c, 30d are then positioned and configured to emit a vibroacoustic stimulation directly into a mattress resting on the support surface 21. In some exemplary embodiments, the exemplary sound transducers used in accordance with the present invention are T25-8 PUCK Tactile Transducers manufactured by Dayton Audio (Springboro, OH).

Of course, it is further contemplated that a number of different types of sound transducers having different properties, as well as different numbers, sizes, or arrangements of sound transducers can also be incorporated into an exemplary power base assembly of the present invention without departing from the spirit and scope of the subject matter described herein. For instance, while the presently-described power base assembly 10 includes a first pair of sound transducers 30a, 30b positioned adjacent to the head portion 23 of the frame 20 and a second pair of sound transducers 30c, 30d positioned adjacent to the foot portion 24 of the frame 20 to allow the power base assembly 10 to be sufficient for effectively emitting vibroacoustic stimulation into a king-or queen-sized mattress, it is contemplated that a single sound transducer at a head portion and a single sound transducer at a foot portion can be suitable for a twin-sized mattress or associated power base assembly.

Regardless of the particular number or arrangement of sound transducers included in an exemplary power base assembly, and referring still generally to FIGS. 1-3, each of the sound transducers 30a, 30b, 30c, 30d are operably connected to a controller 40, typically via a wired connection, that is also secured to the lower side 22b of the support surface 21 and that is configured to individually control the vibroacoustic stimulation emitted by each of the one or more sound transducers 30a, 30b, 30c, 30d. As would be apparent to those skilled in the art, such a controller 40 typically makes use of a processor and a communications module and is programmed to execute instructions stored in memory. The term “memory” is used herein to describe physical devices (computer readable media) used to store programs (sequences of instructions) or data (e.g. program state information) on a non-transient basis for use in an electronic device. In this regard, and as would be appreciated by those skilled in the art, a number of different types of control means can be utilized in accordance with the present invention to control a sound transducer and can be selected for a particular application as desired without departing from the spirit and scope of the subject matter described herein.

With respect to the communications module included in an exemplary controller or other component of the present invention, such communications modules will typically include communications circuitry configured to wirelessly communicate with a remote control 42, a mobile device 100, or an additional processor 46 over wireless communication, as described in further detail below. Such wireless communication can make use of any suitable communication protocol to wirelessly transmit instructions to the controller 40 including, for example, ZigBee, Wi-Fi, Z-Wave, Bluetooth, infrared, and/or other wireless communication protocols or technologies (e.g., non-licensed communications, spread spectrum, frequency hopping, frequency-hopping spread spectrum, and/or the like). Alternatively, in some embodiments, the communication can also be embodied as a wired communication whereby the controller 40 is directly connected to a further component for controlling the operation of an exemplary power base assembly.

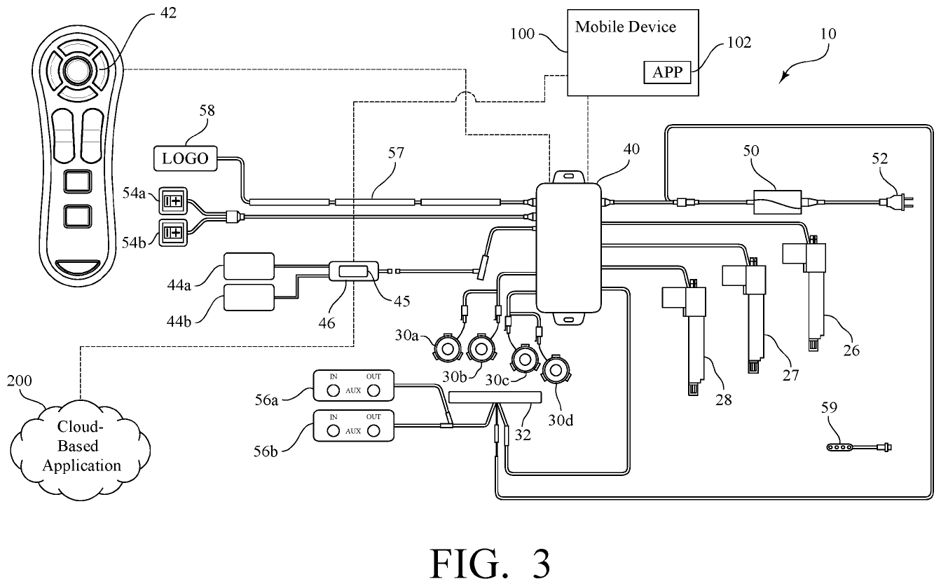

Referring now more particularly to FIG. 3, in addition to the controller 40 being configured to control the vibroacoustic stimulation emitted by the sound transducers 30a, 30b, 30c, 30d, the power base assembly 10 further makes use of and includes a sound bar 32 to control the vibroacoustic stimulation emitted by the sound transducers 30a, 30b, 30c, 30d. For instance, in certain embodiments, the remote control 42 is configured to send a request to the controller 40 to emit a predetermined pattern of vibroacoustic stimulations. The controller 40 then receives the request from the remote control 42 and conveys the request to the sound bar 32. The sound bar 32 subsequently generates the frequency requested by the controller 40 (e.g., a vibroacoustic stimulation at a frequency of 28 Hz, 40 Hz, 52 Hz, 68 Hz, 88 Hz, etc.) and sends the requested frequency out of an audio jack connected to the sound bar 32 and into a corresponding audio jack in the controller 40. In this way, the controller 40 can then amplify the signal from the sound bar 32 corresponding to the intensity selected on the remote control (e.g., low, medium, or high) and send a corresponding amount of power to the sound transducers 30a, 30b, 30c, 30d to emit the desired vibroacoustic stimulation. Sounds bars capable of receiving and transmitting such audio signals can be obtained from any number of commercially-available sources. In some embodiments, such an exemplary sound bar capable of use in the presently-described systems and methods has an input of about 15-20 W, an impedance of about 8 ohm, a resonant frequency (Fo) of about 180 Hz, and is about 301 mm in length, 41 mm in width, and 55 mm in height.

Referring again more generally to FIGS. 1-3, by making use of the controller 40 to individually control the vibroacoustic stimulation emitted by each of the one or more sound transducers 30a, 30b, 30c, 30d, the exemplary power base assembly 10 is further configured for use as part of a system and method for providing a vibroacoustic stimulation to a user resting on a mattress. Vibroacoustic stimulation, which is also sometimes referred to a vibroacoustic therapy, is a form of stimulation which makes use of low frequency sinusoidal sound waves (e.g., 20-120 Hz) that are passed into the body of a user to, in turn, provide relief from aches and pains along with relief from stress and anxiety. Additionally, and without wishing to be bound by any particular theory or mechanism, it is believed that through the use of the power base assemblies of the present invention, vibroacoustic stimulation can be effectively utilized to help users fall asleep faster, spend more time in deep sleep, have a longer duration of sleep, have fewer wake-ups, and have less wakeful time during the night, as described in further detail below.

To provide vibroacoustic therapy to a user resting on a mattress supported by the power base assembly 10 of the present invention, as indicated above, the assemblies, systems and methods of the present invention, in some embodiments, make use of a remote control 42, mobile device 100, and/or an additional processor 46 that are each operably connected to the controller 40 and that communicate instructions to the controller 40 to cause the sound transducers 30a, 30b, 30c, 30d to emit a vibroacoustic stimulation into an overlying mattress, to articulate the head portion 23 or foot portion 24 of the frame 20, or both. In this regard, the remote control 42, the mobile device 100, and/or the additional processor 46 typically includes one or more buttons or is otherwise configured to communicate instructions to the controller 40 to turn the one or more sound transducers 30a, 30b, 30c, 30d on or off, to cause the one or more sound transducers 30a, 30b, 30c, 30d to emit a vibroacoustic stimulation at a predetermined frequency, to raise or lower the intensity of the vibroacoustic stimulation emitted from the one or more sound transducers 30a, 30b, 30c, 30d adjacent to the head portion 23 or the foot portion 24 of the frame 20, and/or to emit a vibroacoustic stimulation in a predetermined pattern of frequencies or intensities to provide a massage to a user resting on the mattress and/or to improve the sleep of the user.

For example, in some embodiments, the remote control 42 includes a button to initiate a “wave,” “pulse,” or a “rolling” massage that, upon being pressed, causes the remote control 42 to communicate with and instruct the controller 40 to initiate a massage program stored in a memory component of the controller 40. That program and the controller 40, in turn, then causes the sound transducers 30a, 30b, 30c, 30d to emit a vibroacoustic stimulation in a predetermined pattern (e.g., in a predetermined pattern of waveforms having varying intensities, frequencies, durations, etc.) to provide such a “wave,” “pulse,” or a “rolling” massage. As another example, in some embodiments, the remote control 42 communicates with and instructs the controller 40 to initiate the emission of a vibroacoustic stimulation at a particular frequency that has been observed to provide relief from and specifically target a condition, such as: a frequency of about 86-88 HZ to provide headache and migraine relief as well as to treat brain-related issues; a frequency of about 40-68 Hz to reduce anxiety and depression; a frequency of about 68 Hz to reduce neck and shoulder pain as well as other muscle tensions; a frequency of about 50 Hz to dislodge lung secretions, clear airways, and improve asthma, bronchitis, etc.; a frequency of about 52 Hz to provide relief from menstrual pains and to reduce lower back pain; a frequency of about 40 Hz to lower blood pressure and relieve other ailments; a frequency of about 27-38 Hz to provide relief from insomnia; and/or a frequency of about 40 Hz to improve blood circulation, to provide vasodilation, and/or to provide relief from spasms. For additional information and guidance as to the frequencies that are useful for targeting specific conditions, and/or ailments, see, e.g., Olav Skille, VibroAcoustic Therapy, Music Therapy, Volume 8, Issue 1, 1989, Pages 61-77, which is incorporated herein by reference in its entirety along with similar references included herein under the section entitled References. In some embodiments, the duration of the emission of a vibroacoustic stimulation to treat such conditions ranges from about 5 minutes to about 60 minutes, including, in certain embodiments, a range of about 10 minutes to about 30 minutes.

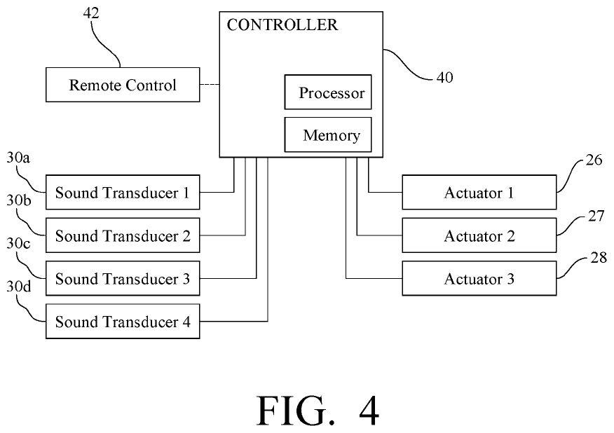

As noted, in one exemplary implementation of a method for providing a vibroacoustic stimulation to a user resting on a mattress, the methods include the steps of: providing a power base assembly of the present invention; receiving, via the controller, instructions to cause the one or more sound transducers to emit a vibroacoustic stimulation in a predetermined pattern of frequencies or intensities; and then transmitting, via the controller, a signal to the one or more sound transducers to emit the vibroacoustic stimulation in the predetermined pattern of frequencies or intensities based on the instructions received by the controller. In some embodiments and implementations of an exemplary system and method of the present invention, and as indicated above, the controller 40 is configured to communicate directly with a remote control 42 to cause the sound transducers 30a, 30b, 30c, 30d to emit the vibroacoustic stimulation in the predetermined pattern of frequencies or intensities, to cause the actuators 26, 27, 28 to articulate the head or foot portion of the frame, or both based on the instructions received by the controller 40 from the remote control 42, as perhaps shown best in FIGS. 3-4.

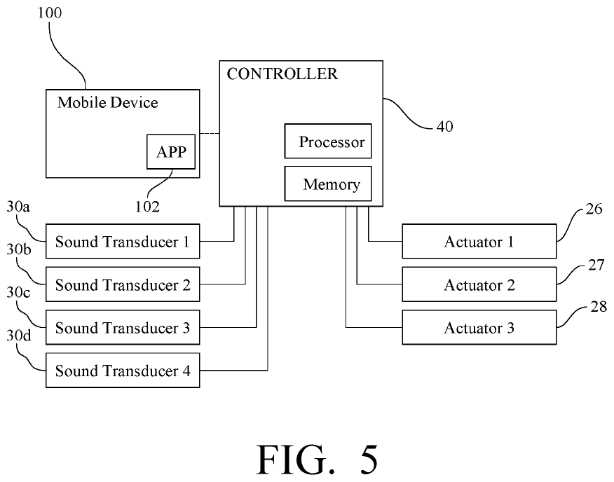

As a refinement, however, in other implementations and embodiments, and referring now to FIGS. 3 and 5, the controller 40 is configured to communicate with a mobile device 100 via a software application 102 running on the mobile device 100. In particular, the software application 102 on the mobile device 100 communicates instructions to the controller 40 to cause the one or more sound transducers 30a, 30b, 30c, 30d to emit a vibroacoustic stimulation in a predetermined pattern of frequencies or intensities, to cause the actuators 26, 27, 28 to articulate the head portion 23 or foot portion 24 of the frame 20, or both. Such mobile devices capable of use in accordance with the present invention include, but are not limited to, smartphones, tablets, or similar devices. Communications between the controller 40 and the mobile device 100 of the user are, similar to the communications between the remote control 42 and the controller 40, generally facilitated through wired or wireless communication schemes. Of course, in some implementations, it is also contemplated that at least some users could also be in communication with the controller 40 of the exemplary power base assembly 10 via a desktop or personal computer with a software component that communicates with the controller, such as via a web- based application accessible through a common internet browser.

With further respect to the communication between the mobile device 100 and the controller 40, in some embodiments and implementations of the systems and methods of the present invention, the software application 102 running on the mobile device 100 communicates instructions to the controller 40 based on measurements made by one or more sensors. For instance, in one embodiment and referring now more specifically to FIG. 3, the exemplary system further includes a pair of biometric sensors 44a, 44b that can be positioned on opposite sides of the upper side 22a of the support surface 21 and beneath a mattress to measure one or more biological characteristics of a user, such as bed entry, sleep onset, heart rate, respiration rate, and movement, and then communicate those biological characteristics to the controller 40 and/or to the software application 102 running on the mobile device 100 through the use of an additional processor 46. In some exemplary embodiments, the exemplary biometric sensors used in accordance with the present invention are comprised of piezo film-based sensors manufactured by TE Connectivity (Berwyn, Pennsylvania), and which function as vibration sensors to measure biological characteristics, such as heart rate, respiration rate, snoring, and movement that result in vibration through the mattress. Of course, in other embodiments, it is also contemplated that other types of biometric sensors that make use of radio waves, pressure transducers, pressure matts, and the like can also be utilized without departing from the spirit and scope of the present invention.

As another example, in some such embodiments, the system further includes an environmental sensor 45 that is operably connected to the additional processor 46 and that measures an environmental condition of the environment in which the power base assembly 10 is located, such as temperature, humidity, and the like, and transmits signals, via the processor 46, to the controller 40 and/or to the mobile device 100 indicative of those environmental conditions. Based on the measured biological characteristics and/or environmental conditions, in some implementations and embodiments, the software application 102 running on the mobile device 100 and, more specifically, the algorithm of the software application of the mobile device is then able to communicate instructions to the controller 40 to cause the one or more sound transducers 30a, 30b, 30c, 30d to emit a particular vibroacoustic stimulation or particular predetermined pattern of frequencies or intensities of vibroacoustic stimulation, to articulate the head portion 23 or the foot portion 24 of the frame 20 in a particular manner, or both in order to target relief for a certain condition and/or to improve the user's sleep quality.

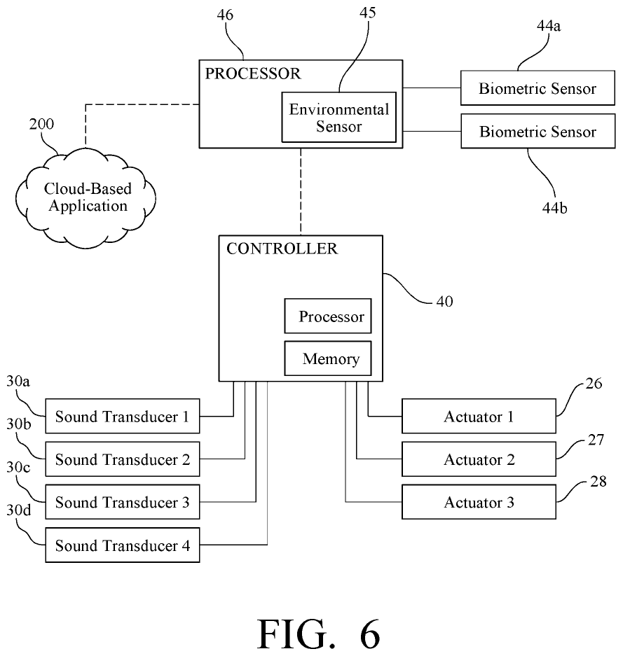

As an even further refinement, in some embodiments and implementations of the systems and methods, rather than communicating with the remote control 42 or the mobile device 100, the controller 40 communicates with the additional processor 46 through the use of cloud-based system or application 200 in which the various control methods and algorithms described for use herein are stored. In particular, and referring now to FIGS. 3 and 6, in one exemplary implementation and embodiment and as indicated above, the additional processor 46 communicates with the biometric sensors 44a, 44b and/or the environmental sensor 45 and receives any measured sensor data. The additional processor 46, which further includes a microcontroller and a communication module (e.g., Wi-Fi or Bluetooth), locally processes the measured sensor data, at least in part, and sends the data, or a portion thereof, to a cloud-based application where the biometric, environmental data, and/or other data is analyzed through use of a software algorithm. Once the cloud-based application determines whether any resulting actions are needed, such as the emission of a particular vibroacoustic stimulation or the articulation of a head portion 23 or foot portion 24 of the frame 20, those actions are then transmitted back wirelessly to the additional processor 46. The additional processor 46 then, in turn, communicates a request to the controller 40 to drive the functions of the power base assembly 10 in the desired manner.

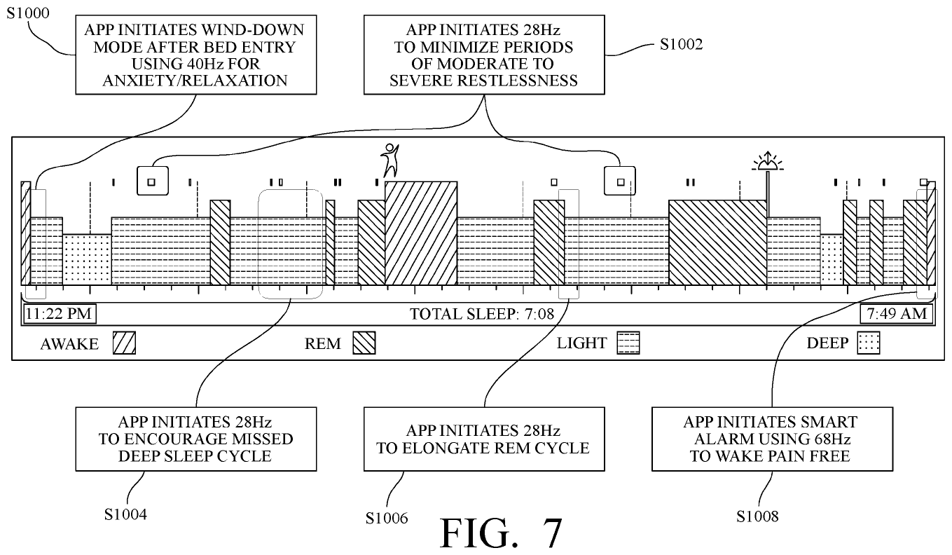

Regardless of whether the remote control 42, the mobile device 100, or the processor 46 and cloud-based application 200 are utilized, in some embodiments and in order to target relief for a certain condition and/or to improve the user's sleep quality, a predetermined pattern of frequencies or intensities of vibroacoustic stimulation can comprises a first frequency or intensity of vibroacoustic stimulation emitted for a first period of time, and a second frequency or intensity of vibroacoustic stimulation emitted for a second period of time that can be the same or different than the first period of time. In some embodiments, the first frequency or intensity of vibroacoustic stimulation is different than the second frequency or intensity of vibroacoustic stimulation. For example, and referring now to FIG. 7, in one exemplary implementation of the system and method of the present invention, the software application 102 running on the mobile device 100 and/or the processor 46 and associated cloud-based application 200 communicates with the biometric sensors 44a, 44b of the power base assembly 10 to not only monitor the individual's biometrics during sleep, but to use those biometrics to identify the user's sleep status and identify opportunities during an individual's sleep cycles where the introduction of certain frequencies of vibroacoustic stimulation can improve the quality of the user's sleep.

For instance, in some embodiments and implementations and with reference to FIGS. 3 and 7, upon the user entering the bed, one or both of the biometric sensors 44a, 44b identify the entry of the user to the bed and communicate that entry to either the software application 102 on the mobile device 100 or the cloud-based application 200 via the processor 46. The software application 102 or cloud-based application 200 then causes the controller 40, either directly or indirectly via the additional processor 46, to initiate a “wind down” mode in which a lower 40 Hz frequency is emitted by one or more of the sound transducers 30a, 30b, 30c, 30d to reduce any anxiety being experienced by the user and to help the user to relax, as indicated by step S1000. As the user then proceeds into his sleep cycles throughout the course of a night, the biometric sensors 44a, 44b continue to monitor the biological characteristics of the user and provide those measured characteristics for processing and analysis by the software application 102 running on the mobile device 100 or by the cloud-based application 200 via the additional processor 46. Based on the identified sleep status of the user, the software application 102 or cloud-based application 200 is then subsequently able to initiate the emission of a vibroacoustic stimulation at a frequency of 28 Hz at various points throughout the night in order to encourage a missed deep sleep cycle as indicated by step S1004, elongate a particular REM cycle as indicated by step S1006, and or minimize a particular period of restlessness as indicated by step S1002. At the end of user's overnight sleep, the software application 102 or cloud-based application 200 then initiates the emission of a vibroacoustic stimulation at a frequency of 68 Hz to awaken the user and to do so in a manner whereby the user's neck and shoulder pain as well as other muscle tensions or pain is reduced or eliminated, as indicated by step S1008.

Referring again to FIGS. 1-3, as another example of an implementation of an exemplary system and method of the present invention, in some implementations and in addition to making use of the system to provide a vibroacoustic stimulation to improve a user's sleep, an exemplary power base assembly 10 and system of the present invention is further used to articulate the head portion 23 or foot portion 24 of the frame 20. In one such exemplary implementation, upon entering bed, the remote control 42, the software application 102 running on the mobile device 100, and/or the processor 46 associated with an exemplary system is used to initiate an automated sequence of actions whereby, upon entry into the bed and the pressing of an appropriate button on the remote control 42 or mobile device 100, an under bed light 57 or a name plate light 58 is turned on and the frame 20 is articulated into a first position in which the head portion 23 and foot portion 24 of the frame 20 are each raised to a moderately elevated position. At that time, the sound transducers 30a, 30b positioned adjacent to the head portion 23 of the frame 20 as well as the sound transducers 30c, 30d associated with the foot portion 24 of the frame 20 are made to emit a vibroacoustic stimulation to provide a massage to the user resting on the mattress. After a predetermined period of time (e.g., 5 min), the head portion 23 of the frame 20 is then made to move to a less articulated position and the sound transducers 30a, 30b positioned adjacent to the head portion 23 are made to provide less of a massage. At that same time though, the elevation of the foot portion 24 of the frame 20 and the massage being provided by the sound transducers 30c, 30d adjacent to the foot portion 24 remain at the same, higher levels. Subsequently, after another predetermined period of time (e.g., 7 min), the frame 20 is articulated to a “zero g” position whereby the head portion 23 of the frame 20 is articulated further downward and the foot portion 24 of the frame is articulated slightly upward. The sound transducers 30a, 30b adjacent to the head portion 23 of the frame 20 are then turned off along with the lights 57, 58, while the sound transducers 30c, 30d adjacent to the foot portion 24 of the frame are made to provide a low level massage. After another predetermined period of time (e.g., 7 min), the remaining active sound transducers 30c, 30d are then turned off and the frame 20 is articulated to a flat position.

In some further implementations of the systems and methods of the present invention in which an exemplary power base assembly and system of the present invention is used to articulate the head or foot portion of the frame and to provide a vibroacoustic stimulation in predetermined patterns or frequencies to improve a user's sleep, the systems and methods of the present invention do so based on the sleep status of the user as identified and determined by the biometric sensors in conjunction with the software application running on the mobile device or in conjunction with the cloud-based application communicating with the additional processor. For instance, in some implementations, a user's sleep stages are monitored by the biometric sensors, such as the biometric sensors 44a, 44b shown in FIG. 3, that are underneath the mattress and are used to provide input to the cloud-based application 200 via the processor 46 or to the software application 102 running on the mobile device 100. Upon receiving instructions from the processor 46 or the mobile device 100, the controller 40 can then cause the frame 20 to articulate and/or can cause the sound transducers 30a, 30b, 30c, 30d to emit a particular vibroacoustic stimulation to wake the user when they are in a light stage of sleep as opposed to a deep or REM sleep cycle.

As another example, in some implementations, the biometric sensors 44a, 44b monitor the heart rate, respiratory rate, and movement of a user resting on the mattress to derive the sleep stages of the user (e.g., awake, REM, light, deep) while the environmental sensor 45 monitors nightly environmental conditions for bedroom air purity (VOCs), carbon dioxide (eCO2), humidity, and temperature to provide a nightly sleep quality assessment that can then be utilized to provide recommendations for various intervention points in which the frame 20 can be articulated and/or the sound transducers 30a, 30b, 30c, 30d can be made to emit a particular vibroacoustic stimulation to improve the quality of the user's sleep.

As yet another example, in some implementations, the biometric sensors 44a, 44b can detect disturbances in normal breathing patterns due to snoring without the use of microphones. Through the detection of such abnormal breathing patterns, the processor 46 and cloud-based application 200 and/or the software application 102 running on the mobile device 100 can identify that the user is snoring and, via the controller 40, raise the head portion 23 of the frame 20 to a predefined angle and/or cause the sound transducers 30a, 30b, 30c, 30d to emit a particular vibroacoustic stimulation in response to the snoring before, possibly, returning the user to the flat position after snoring has ceased for some period of time.

Lastly, in addition to the above-described features, the exemplary power base assemblies, systems, and methods of the present invention can also incorporate and make use of a number of additional features to improve the functionality of the assemblies, systems, and methods. For instance, in the exemplary power base assembly 10 shown in FIGS. 1-3 and as indicated above, the power base assembly 10 further includes a sound bar 32 operably connected to the one or more sound transducers 30a, 30b, 30c, 30d, such that the sound bar 32 can transmit an audio signal to the one or more sound transducers 30a, 30b, 30c, 30d (e.g., via the controller 40) to allow the sound transducers 30a, 30b, 30c, 30d to emit the bass or thumping portion of the audio signals through the transducers 30a, 30b, 30c, 30d as a vibroacoustic stimulation. Additionally, the power base assembly 10 can include USB charging ports 54a, 54b for connecting and/or charging another device, a power supply 50 and a power cord 52 for providing power to the power base assembly 10, and a battery back-up 59.

All publications, patents, and patent applications mentioned in this specification are herein incorporated by reference to the same extent as if each individual publication, patent, or patent application was specifically and individually indicated to be incorporated by reference, including the references set forth in the following list:

### REFERENCES

1. Campbell, E. A. Vibroacoustic Treatment and Self-Care for Managing the Chronic Pain Experience: An Operational Model. Ph.D. Thesis, University of Jyväskylä, Jyväskylä, Yliopisto, Finland, 2019.
2. Lundeberg, T.; Nordemar, R.; Ottoson, D. Pain alleviation by vibratory stimulation. Pain 1984, 20, 25-44.
3. Zoppi, M.; Voegelin, M. R.; Signorini, M.; Zamponi, A. Pain threshold changes by skin vibratory stimulation in healthy subjects. Acta Physiol. Scand. 1991, 143, 439-444.
4. Hollins, M.; Roy, E. A.; Crane, S.A. Vibratory antinociception: Effects of vibration amplitude and frequency. J. Pain 2003, 4, 381-391.
5. Kakigi, R.; Shibasaki, H. Mechanisms of pain relief by vibration and movement. J. Neurol. Neurosurg. Psychiatry 1992, 55, 282-286.
6. Hollins, M.; McDermott, K.; Harper, D. How does vibration reduce pain? Perception 2014, 43, 70-84.
7. Cerciello, S.; Rossi, S.; Visonà, E.; Corona, K.; Oliva, F. Clinical applications of vibration therapy in orthopaedic practice. Muscles. Ligaments Tendons J. 2016, 6, 147-156.
8. Lurie, R. C.; Cimino, S. R.; Gregory, D. E.; Brown, S. H. M. The effect of short duration low back vibration on pain developed during prolonged standing. Appl. Ergon. 2018, 67, 246-251.
9. Cochrane, D. J. Effectiveness of using wearable vibration therapy to alleviate muscle soreness. Eur. J. Appl. Physiol. 2017, 117,501-509.
10. Veqar, Z.; Imtiyaz, S. Vibration Therapy in Management of Delayed Onset Muscle Soreness (DOMS). J. Clin. Diagn. Res. 2014, 8, LE01-LE04.
11. Muceli, S.; Farina, D.; Kirkesola, G.; Katch, F.; Falla, D. Reduced force steadiness in women with neck pain and the effect of short term vibration. J. Electromyogr. Kinesiol. 2011, 21, 283-290.
12. Desmoulin, G. T.; Szostek, J. S.; Khan, A. H.; Al-Ameri, O. S.; Hunter, C. J.; Bogduk, N. Spinal intervention efficacy on correcting cervical vertebral axes of rotation and the resulting improvements in pain, disability and psychsocial measures. J. Musculoskelet. Pain 2012, 20, 31-40.
13. Wigram, T. The psychological and physiological effects of low frequency sound and music. Music Therapy Perspectives 13 (1995) 16-23.
14. Wigram, T, Pedersen, IN, Bonde, LO. A Comprehensive Guide to Music Therapy; Theory, Clinical Practice, Research and Training. (2002) Jessica Kingsley Publishers, London.
15. Saluveer, E and Tamms, S. Vibroacoustic therapy with neurotic clients at the Talinn Pedagogical Institute. Paper given at the Second International Symposium in Vibroacoustics. (1989) Steinkjer, Norway.
16. Ruutel, E. The psychophysiologocal effects of music and vibroacoustic stimulation. Nordic Journal of Music Therapy 11 (2002).
17. Skille, O. and Wigram, A. (1995) The effects of music, vocalization and vibrations on brain and muscle tissue. Studies in vibroacoustic therapy. In Wigram, A., Saperston, B. and West, R. (Eds.) The Art and Science of Music Therapy: a Handbook. London: Harwood Academic.
18. Chesky, K. S., Rubin, B. and Frische, E. (1992) The Pain Relieving Effect of Music Vibration on Rheumatoid Arthritis Patients as Related to Just Music and Placebo. ISME.
19. Hooper J. An introduction to vibroacoustic therapy and an examination of its place in music therapy practice. Br J Music Ther 2001;5:69-77.
20. Lehikoinen, Petri. The physioacoustic method. In: Wigram T, Dileo C, eds. Music Vibration and Health, Cherry Hill, NJ: Jeffrey Books, 1997; 209-216.
21. Patrick G. The effects of vibroacoustic music on symptom reduction: inducing the relaxation response through good vibrations. IEE Eng Med Biol Mag 1999; 18:97-100.
22. Brewer C. Boyd, Coope V. Effectiveness of vibroacoustic music for pain and symptom management in outpatient chemotherapy treatment. First International Institute on Arts in Healing, May 16-17, 2003. Christine E. Lynn College of Nursing, Florida Atlantic University, Boynton Beach, FL
23. Walters C. The psychological and physiological effects of vibrotactile stimulation via a Somatron, on patients awaiting scheduled gynecological surgery. J Music Ther 1996;33:261-287.
24. Brewer C. The Somatron Pain and Anxiety Management Program. The Somatron Corporation, 2000.
25. Chesky K S, Michel DE. The Music Vibration Table (MVT): Developing a technology and conceptual model for pain relief. Music Ther Perspect 1991;9:32-37.
26. Chesky K S, Michel D E, & Kondraske G. Developing methods and techniques for scientific and medical application of music vibration. In: Spintge R, Dron R eds. Music Medicine, vol 2. St. Louis, MO: MMB Music. 1996;2:227-241.
27. Lundenberg T, Nordemarr R, Ottoson D. Pain alleviation by vibratory stimulation. Pain 1984;20:2-44
28. Quillian T A, Sato M. The distribution of myelin and nerve fibres from Pacinian Corpuscles. J Physiol, 1955; 129:167-176.
29. Hubbard S J. A study of rapid mechanical events in a mechanoreceptor. J Physiol 1958;141:198-218.
30. Dileo C. The context of music and medicine. In: Wigram T, Dileo C, eds. Music Vibration and Health. Cherry Hill, NJ: Jeffrey Books, 1997:37-48.

One of ordinary skill in the art will recognize that additional embodiments are also possible without departing from the teachings of the present invention or the scope of the claims which follow. This detailed description, and particularly the specific details of the exemplary embodiments disclosed herein, is given primarily for clarity of understanding, and no unnecessary limitations are to be understood therefrom, for modifications will become apparent to those skilled in the art upon reading this disclosure and may be made without departing from the spirit or scope of the claimed invention.

1. A method for providing a vibroacoustic stimulation to a user resting on a mattress, comprising:
providing a power base assembly for a mattress, the power base assembly including
a support surface for supporting the mattress, the support surface including a first upper side and a second lower side,
a frame positioned adjacent to and operably connected to the second lower side of the support surface,
one or more sound transducers operably connected to the support surface and/or the frame, the one or more sound transducers positioned at predetermined locations on the support surface and/or the frame, and
a controller operably connected to each of the one or more sound transducers, the controller including a communications module and a processor;
receiving, via the controller, instructions to cause the one or more sound transducers to emit a vibroacoustic stimulation in a predetermined pattern of frequencies or intensities; and
transmitting, via the controller, a signal to the one or more sound transducers to cause the one or more sound transducers to emit a vibroacoustic stimulation in the predetermined pattern of frequencies or intensities, the signal based on the instructions received by the controller,
wherein the power base assembly further comprises one or more biometric sensors for measuring one or more biological characteristics of a user, and
wherein the method further comprises:
transmitting the one or more measured biological characteristics of the user to a mobile device via a software application running on the mobile device or to a cloud-based application;
processing, via the software application on the mobile device or via the cloud-based application, the one or more biological characteristics to identify a sleep status of a user; and
transmitting, via the software application on the mobile device or via the cloud-based application, instructions to the controller to emit a particular vibroacoustic stimulation based on the identified sleep status of the user.

2. The method of claim 1, wherein the predetermined pattern of frequencies or intensities of vibroacoustic stimulation comprises
a first frequency or intensity of vibroacoustic stimulation emitted for a first period of time; and
a second frequency or intensity of vibroacoustic stimulation emitted for a second period of time.

3. The method of claim 2, wherein the first frequency or intensity of vibroacoustic stimulation is different than the second frequency or intensity of vibroacoustic stimulation.

4. The method of claim 2, wherein the first period of time is different than the second period of time.

5. The method of claim 1, further comprising transmitting the instructions to the controller from a remote control, a cloud-based application, and/or or a mobile device.

6. The method of claim 5, wherein transmitting the instructions to the controller from the remote control, the cloud-based application, or the mobile device comprises transmitting instructions from the cloud-based application.

7. The method of claim 1, wherein the frame is an articulating frame including a head portion and a foot portion, and
wherein the method further comprises:
receiving, via the controller, the instructions from a remote control, a cloud-based application, or a mobile device to articulate the head portion and/or the foot portion of the frame; and
transmitting, via the controller, a signal to one or more actuators operably connected to the head portion or the foot portion of the frame to articulate the head portion or the foot portion of the frame.

8. The method of claim 1, wherein the power base assembly further comprises one or more biometric sensors for measuring one or more biological characteristics of a user, and
wherein the method further comprises transmitting, via the controller, a signal to the one or more sound transducers to cause the one or more sound transducers to emit a particular vibroacoustic stimulation based on the one or more biological characteristics of the user.

9. (canceled)

10. The method of claim 1, wherein the frame is an articulating frame including a head portion and a foot portion, and
wherein the method further comprises transmitting, via the software application on the mobile device or via the cloud-based application, instructions to the controller to articulate the head portion, the foot portion or both based on the identified sleep status of the user.

11. A system for providing a vibroacoustic stimulation to a user resting on a mattress, comprising:
a support surface for supporting a mattress, the support surface including a first upper side and a second lower side;
a frame positioned adjacent to and operably connected to the second lower side of the support surface;
one or more sound transducers operably connected to the support surface and/or the frame, the one or more sound transducers positioned at predetermined locations on the support surface and/or the frame and configured to emit a vibroacoustic stimulation into the mattress resting on the support surface;
a controller operably connected to each of the one or more sound transducers, the controller including a communications module and a processor, and the controller for individually controlling the vibroacoustic stimulation emitted by each of the one or more sound transducers;
a remote control, a cloud-based application, or a mobile device in communication with the controller; and,
one or more biometric sensors operably connected to the controller, the one or more biometric sensors for measuring one or more biological characteristics of a user resting on the mattress and for providing input to the controller to cause the one or more sound transducers to emit a vibroacoustic stimulation in a predetermined pattern of frequencies or intensities in response to the measured biological characteristics,
wherein the controller is configured to receive instructions from the remote control, the cloud-based application, or the mobile device to cause the one or more sound transducers to emit a vibroacoustic stimulation in a predetermined pattern of frequencies or intensities, and
wherein the controller is further configured to:
transmit the one or more measured biological characteristics of the user to the mobile device via a software application running on the mobile device or to the cloud-based application; and
receive, from the software application on the mobile device or from the cloud-based application, instructions to emit a particular vibroacoustic stimulation based on a sleep status of the user, the sleep status identified by the software application on the mobile device or by the cloud-based application after processing the one or more biological characteristics.

12. The system of claim 11, wherein the frame is an articulating frame including a head portion and a foot portion.

13. The system of claim 11, wherein the controller is configured to communicate with the mobile device via a software application running on the mobile device.

14. The system of claim 13, wherein the software application on the mobile device further communicates instructions to the controller to articulate a head or a foot portion of the frame, or both.

15. (canceled)

16. A power base assembly, comprising:
a support surface for supporting a mattress, the support surface including a first upper side and a second lower side;
a frame positioned adjacent to and operably connected to the second lower side of the support surface;
one or more sound transducers operably connected to the support surface and/or the frame, the one or more sound transducers positioned at predetermined locations on the support surface and/or the frame and configured to emit a vibroacoustic stimulation into a mattress resting on the support surface;
a controller operably connected to each of the one or more sound transducers, the controller for individually controlling the vibroacoustic stimulation emitted by each of the one or more sound transducers, and the controller configured to cause the one or more sound transducers to emit a vibroacoustic stimulation in a predetermined pattern of frequencies or intensities; and,
one or more biometric sensors operably connected to the controller, the one or more biometric sensors for measuring one or more biological characteristics of a user resting on the mattress and for providing input to the controller to cause the one or more sound transducers to emit a vibroacoustic stimulation in a predetermined pattern of frequencies or intensities in response to the measured biological characteristics,
wherein the controller is further configured to
transmit the one or more measured biological characteristics of the user to a mobile device via a software application running on the mobile device or to a cloud- based application, and
receive, from the software application on the mobile device or from the cloud-based application, instructions to emit a particular vibroacoustic stimulation based on a sleep status of the user, the sleep status identified by the software application on the mobile device or by the cloud-based application after processing the one or more biological characteristics.

17. The power base assembly of claim 16, wherein the frame is an articulating frame.

18. The power base assembly of claim 16, wherein the frame includes a head portion and a foot portion, and wherein the one or more sound transducers comprise a first pair of sound transducers positioned adjacent to the head portion of the frame and a second pair of sound transducers positioned adjacent to the foot portion of the frame.

19. The power base assembly of claim 16, wherein each of the one or more sound transducers are configured to emit a vibroacoustic stimulation at frequencies ranging from about 20 Hz to about 150 Hz.

20. The power base assembly of claim 16, further comprising a sound bar operably connected to the one or more sound transducers, the sound bar for transmitting an audio signal to the one or more sound transducers via the controller.

21. (canceled)

22. The power base assembly of claim 16, further comprising one or more environmental sensors operably connected to the controller, the one or more environmental sensors for measuring a local environmental condition.

23. The power base assembly of claim 22, wherein the environmental sensors provide input to the controller to cause the one or more sound transducers to emit a vibroacoustic stimulation in a predetermined pattern of frequencies or intensities in response to the measured local environmental condition.
